(19) United States
(12) Patent Application Publication
(10) Pub. No.: US 2006/0221173 A1
(43) Pub. Date: Oct. 5, 2006

(54) Shared experience of media content

(75) Inventor: Bruce Duncan, Reading (GB)

Correspondence Address: Philips Electronics North America Corporation;Corporate Patent Counsel, P O Box 3001, Briarcliff Manor, NY, 10510, US

(73) Assignee: Koninklijke Philips Electronics N.V., Eindhoven (NL)

(21) Appl. No.: 10/567,223

(22) PCT Filed: Jul. 30, 2004
(86) PCT No.: PCT/IB04/02575

§ 371 Date: Feb. 3, 2006

(30) Foreign Application Priority Data
Aug. 5, 2003 (GB) 0318290.4

(51) Int. Cl. H04N 7/14

(52) U.S. Cl. 348/14.02

(57) ABSTRACT

Terminals (110) at premises (100, 200, 250) of a group of users allow the group to collectively experience and discuss media content selected by a member of the group. Terminals (110) are interconnected via a network (internet 300). Terminal (110) receives a first user's selection of media content, such as a television channel, for presentation by a media presentation device (e.g. television receiver 150) local to the terminal (110). Terminal (110) forwards an identifier of the selected media content to other terminals at premises (200, 250) over the network (300). Other terminals receive, via network (300), the identifiers of media content selected by the first user and instruct a media presentation device local to them to present the same media content In the event that a terminal cannot access the selected content using one of it's local media presentation devices, it may seek an alternative source, such as an online source on the network (300).

This invention relates to discussion groups and to terminals for allowing a user of a discussion group to have a shared experience of media content with other users.

A popular feature provided by many internet web hosting services is that of chat rooms, which are also known as communities or forums. Chat rooms are shared spaces in which many people can participate in the same text-based conversation in real-time. Generally, a user composes a text message in a small window on their personal computer (PC), or other internet-connected terminal, and submits this to the host of the chat room via their internet connection. All submitted messages to a chat session are immediately added to the bottom of a scrolling window which is received and viewed by all participants in the chat session.

There are various ways in which the subject of a chat room can be selected. In Internet Relay Chat (http://www.irc.org), the original chat system dating from 1988, the current topic of discussion can be set by any participant and is explicitly displayed. Some chat room hosts choose a subject for discussion during a particular time. One example of a discussion topic is a popular television programme. Often, an advertising feature broadcast after the television programme may advertise the availability of a chat room for discussing the latest episode of the programme and the participants in the chat room discussion may include a member of the cast or production team of the programme. In it's simplest form, a user views the broadcast programme and then separately logs on to their PC to access the chat room. In a development of this, such as that shown in WO01/50753, a television set-top box is provided with a connection to the chat room host to allow the user to participate in a chat session which is related to the -programme currently being viewed. Indeed, the chat room text can be displayed on the same television screen as the programme to which the chat relates. Chat rooms and other web content may be linked more closely to a particular television programme by sending a stream of web addresses, either directly to a user's PC or by embedding the addresses in the broadcast AV signal.

In each of these arrangements a discussion group is usually limited to whatever topic has been selected in advance.

In a further development of chat rooms, known as ‘co-browsing’, on-line users can co-ordinate their chat with internet browsing. Participants in a co-browsing group can send, or ‘push’, uniform resource locators (URLs) to each other. Browser software on the PC of each participant automatically loads the page located at the URL which is received from another participant in the group. This enables the group of participants to experience, together, a guided tour of interesting web sites on the internet. Usually, the tour would be under the direction of a designated tour leader.

US 2002/0184634 describes a system where a person, or group of people, may experience a ‘TV ride’ which consists of an automated sequence of TV programming which is generated by a host system or by one of the viewers. The automated sequence is selected in advance of viewing. A discussion group may be formed to discuss the TV ride, with the host co-ordinating the distribution of the TV ride line up to others. This again restricts discussion to whatever content has been selected in advance.

Finally, Japanese Publication JP 2001-184292 describes a system where a number of client computers are connected through a network to a shared server and a common chat room. When one of the clients requests particular music, all of the clients receive the selected music data from the shared server. This has the disadvantages of burdening the server with delivering music data to all of the clients and restricts discussion to the music content held by the server.

The present invention seeks to offer greater freedom to users of chat rooms or discussion groups.

Accordingly, a first aspect of the present invention provides a terminal for allowing a first user to have a shared experience of media content with a group of other users who are interconnected with the first user via a network, comprising:

an input for receiving the first user's selection of media content for presentation, substantially in real-time, by a media presentation device local to the terminal, the media presentation device using a delivery mechanism which is independent of the network;

means for determining an identifier corresponding to the selected media content;

means for sending the identifier to terminals of the other users in the group over the network; and,

means for allowing the first user to discuss the media content with the other users in the group.

This allows the first user to steer the group's discussion between media content of his individual choosing, such as television or radio programmes, in real-time, without being restricted to the media content which is available on the network which interconnects them. Thus, a group of people can remain together in one chat room while discussing a range of different media content. Preferably each terminal of the group of users has this functionality so that each user of the group has the opportunity to select what media the group experiences.

The term ‘delivery mechanism’ is intended to mean the means by which the media content is delivered to the media presentation device. Where the media presentation device is a television or radio receiver, the delivery mechanism is a broadcast channel. Where the media presentation device is a media jukebox local to the first user then the delivery mechanism is simply a streaming operation from a source of storage within the jukebox. Because the delivery mechanism is independent of the network which interconnects the terminals, the variety of media available for discussion is greater and the network is not burdened with delivering the media content to each user in the group. Instead, the group will be able to collectively enjoy high quality content distributed via existing, wide bandwidth, delivery channels to their premises.

Preferably the terminal further comprises:

means for receiving, via the network, an identifier of media content selected by another user of the group;

means for determining a source of media content corresponding to the received identifier; and,

means for selecting the determined source on a media presentation device local to the receiver.

Preferably each terminal of the group of users has this functionality. In use media presentation devices, such as television or radio broadcast receivers, of each of the members of the group simultaneously switch in response to the selection made by one member of the group to provide a shared context for discussion.

Preferably, the means for allowing the user to discuss the media content is an internet chat application which communicates with an external host. The identifiers of media content can be sent to, or received from, the external host along with messages of the chat application.

The media content can take the form of broadcast television or radio programmes which are received by a broadcast receiver local to the terminal, or content stored locally to the terminals of each of the users in the group. In the event that the user selects to view a broadcast channel, it is preferred to determine an identifier corresponding to a programme currently being broadcast on the selected channel. This helps to accurately identify the media content to others even where there are differences between the ways members of the group have set up their media presentation devices, where members of the group have different access to delivery mechanisms (e.g. no access to satellite channels) or where there are regional (or national) variations in programming. An identifier of the programme can be determined by accessing a source of programme information to determine which programme is being broadcast on the selected broadcast channel. The online source can be an online or broadcast source of programme information such as an electronic programme guide (EPG).

Preferably, the terminal is arranged to find an alternative source for the identified media content in the event that the terminal cannot find, or cannot access, broadcast channels carrying the content. The alternative source may be an online source.

The terminal can take the form of a remote control for the media presentation device, a set-top box or a PC, which has access to the network which interconnects users in the group.

Another aspect of the invention provides a method of operating a terminal in this manner.

The functionality described here can be implemented in hardware, software or a combination of these. Accordingly, other aspects of the invention provide a control apparatus for a terminal and software for controlling operation of the terminal. The software may be installed on the terminal at the time of manufacture or it may be installed onto an existing terminal at a later date as an upgrade. The software may be stored on an electronic memory device, hard disk, optical disk or other machine-readable storage medium. The software may be delivered on a machine-readable carrier or it may be downloaded via a network.

It is noted that some users, such as those on a cable television (CATV) distribution system, will receive broadcast channels on the same physical cable as that used for internet access. Although these two types of signal may share a common cable over a short distance, the broadcast channels are to be construed as being an independent delivery mechanism from the network which interconnects the users for the purposes of this application. Thus, these systems are intended to fall within the scope of the invention.

Embodiments of the present invention will now be described, by way of example only, with reference to the accompanying drawings, in which:

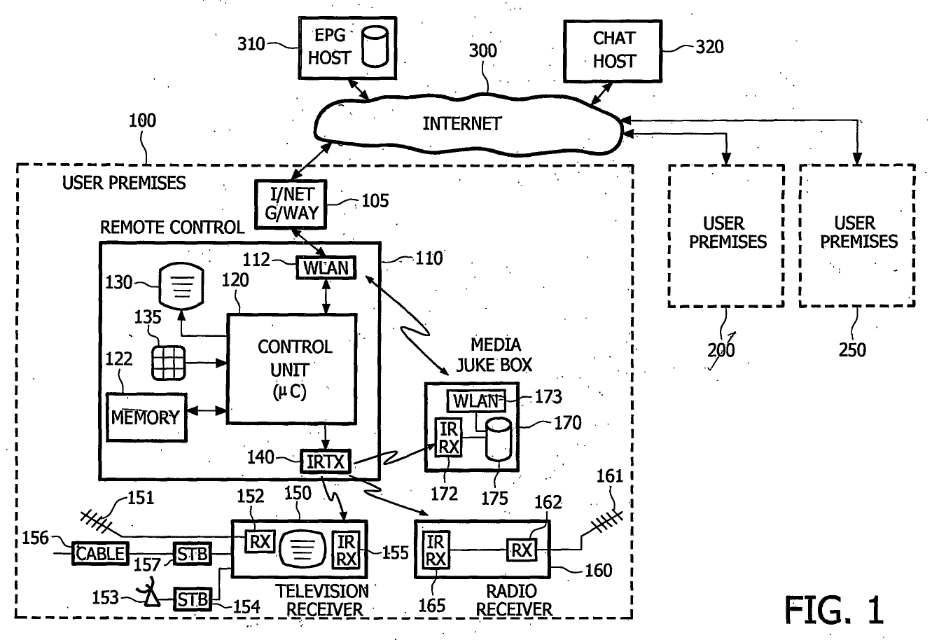

FIG. 1 shows a first system embodying the invention;

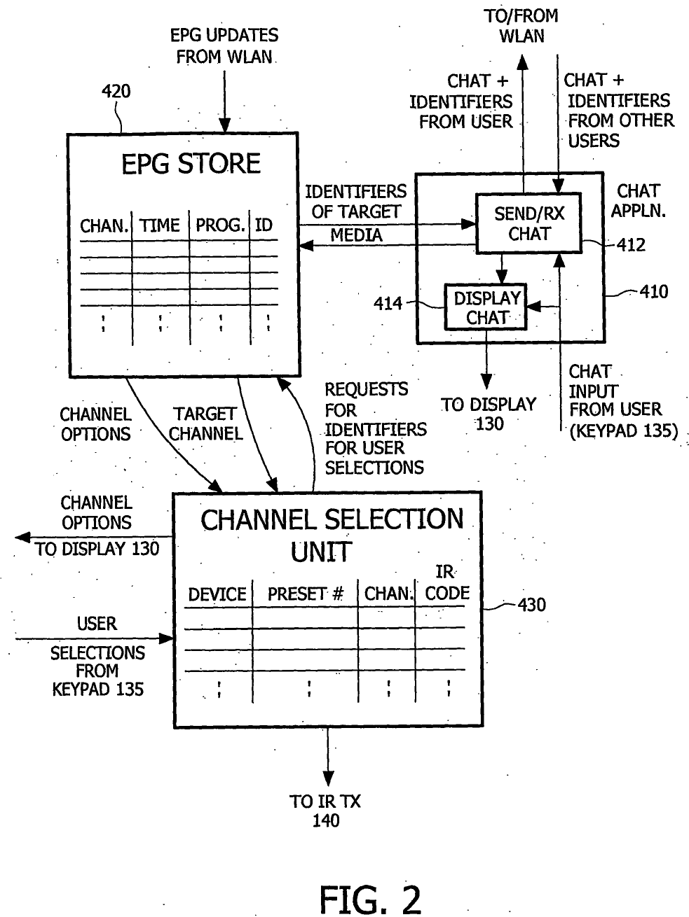

FIG. 2 shows functional units within the remote control unit shown in FIG. 1;

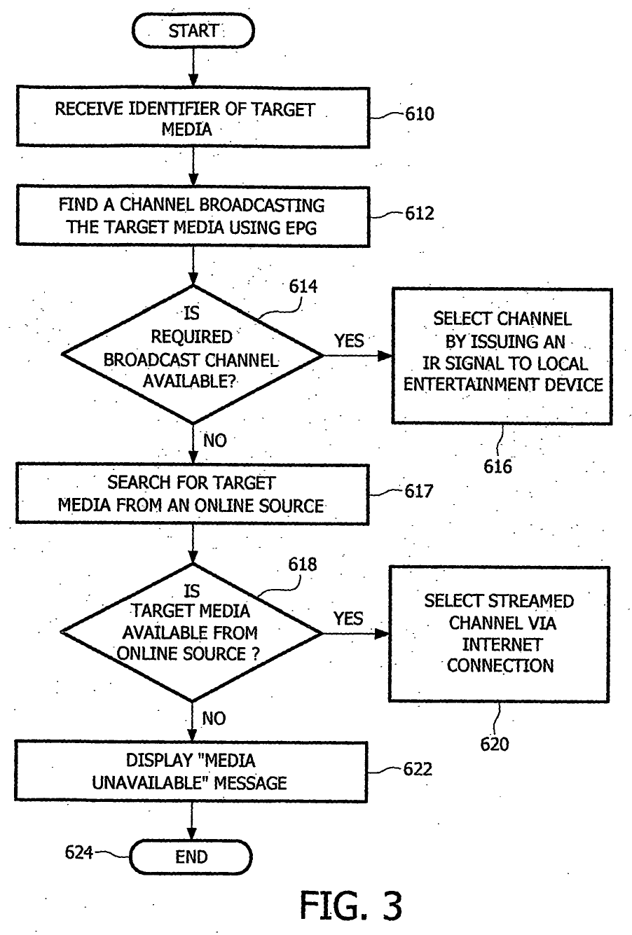

FIG. 3 shows a flow chart of steps performed by a receiving terminal;

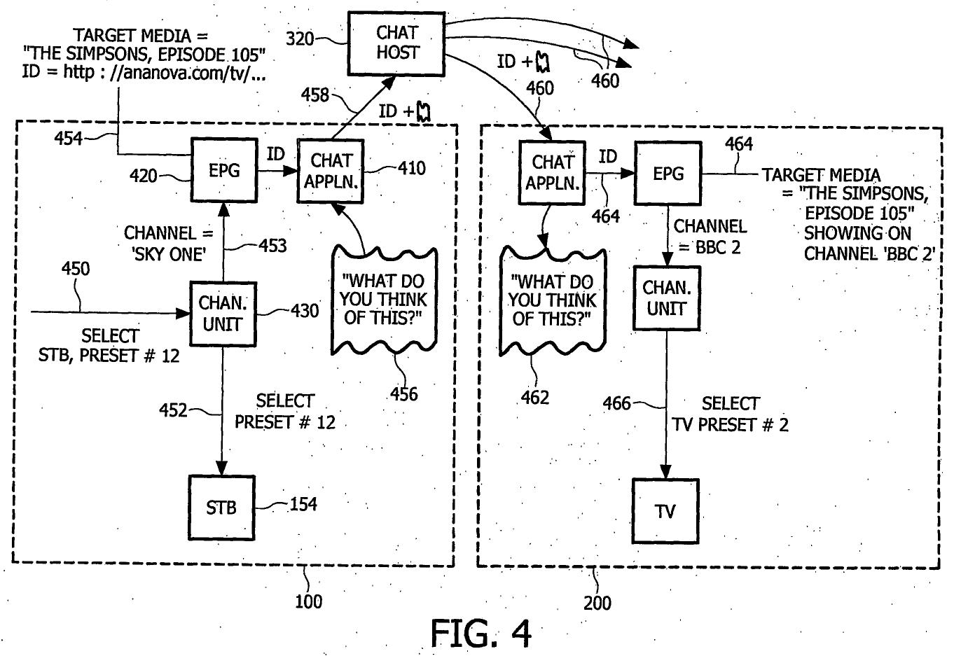

FIG. 4 shows message flows during an example scenario; and,

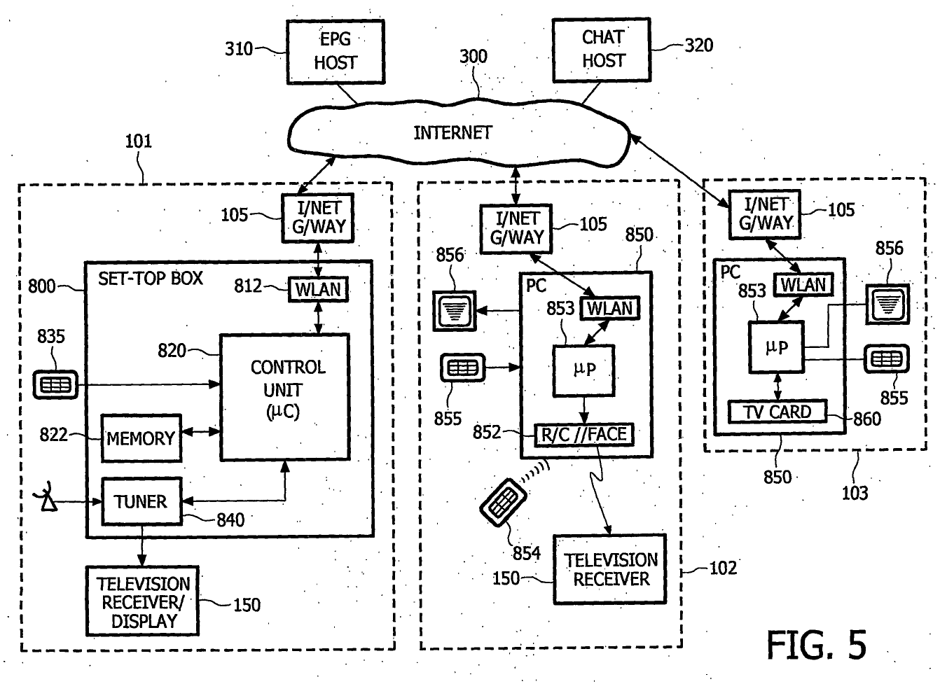

FIG. 5 shows alternative embodiments of the invention.

FIG. 1 shows a first example of a system embodying the invention. For clarity, only three user premises 100, 200, 250 are shown although it will be appreciated that a larger number of user premises, each having similar equipment as premises 100, can be interconnected in the same manner. At each user premises 100, 200, 250 there is a remote control unit 110 and a plurality of home media presentation devices 150, 160, 170. The remote control unit 110 can be, for example, an ‘iPronto™’ wireless remote control manufactured by Royal Philips Electronics. As in a conventional remote control unit, remote control 110 allows a user to control operation of a variety of consumer home entertainment products such as a television receiver 150, radio receiver 160 and media jukebox 170. The remote control unit 110 comprises a microprocessor 120 and memory 122, a user input device 135 for allowing a user to make selections, a display 130 for displaying to the user the current operating conditions and selections and an infrared transmitter 140 for transmitting infrared control signals to media presentation devices 150, 160, 170. In addition, the remote control unit 110 also has access to the Internet via a wireless LAN transmitter/receiver 112 in the remote control unit 110 and a corresponding wireless LAN transmitter/receiver in an Internet gateway 105 at the premises 100. The wireless LAN can operate according to IEEE 802.11b (WiFi) or any other suitable format. The user input device 135 can be a simple keypad, or it can be a more complex device such as a tablet with a touch-sensitive screen which is combined with the display 130, with context-sensitive labels and ‘soft buttons’ displayed on the display 130 under the control of microprocessor 120. Display 130 is preferably a liquid crystal display (LCD) panel.

Three different types of home media presentation devices 150, 160, 170 are shown. A user's premises may have only one of these devices or it may have a greater variety than what is shown here. As the media presentation devices themselves are known, they will only be briefly described. Television receiver 150 can receive and display broadcast video signals from one or more sources. These sources can include terrestrial broadcasts which are received via an antenna 151 and a receiver 152. In the case of digital terrestrial transmissions, such as those broadcast using Orthogonal Frequency Division Multiplexing (OFDM), a set top box (not shown) may be required. The broadcast signals may also be received via satellite or cable delivery schemes, in which case the television 150 has a suitable antenna 153 and set-top box (STB) 154, 157 to demodulate and decode the received signals in a known manner. The television receiver has a remote control receiver 155 for receiving control signals from the transmitter 140. Although not shown, set-top boxes 154, 157 may also include remote control receivers for receiving control signals in the same manner.

Radio receiver 160 has a suitable antenna 161 and receiver 162 for receiving broadcast radio signals and a remote control receiver 165 for receiving control signals from the transmitter 140. Radio signals may be broadcast in analogue form (such as frequency modulated (FM) signals in the VHF band) or in digital form such as Digital Audio Broadcasting (DAB).

Media jukebox 170 comprises a store of media content in audio and/or video form. The store can take the form of a collection of optical disks, a hard drive, memory chip or some other form of storage device.

Premises 100, 200, 250 are interconnected via the Internet 300. Also connected to the Internet are two hosts 310, 320 which are each accessible by the remote control units 110 at the premises. Host 310 has a server which stores an electronic programme guide (EPG) of media content. One example of an electronic programme guide is that provided by Ananova™ and available at http://www.ananova.com/tv/. The electronic programme guide will include listings of all television programmes for a range of popular broadcast television channels. Similar online electronic programme guides are available for radio channels.

Also connected to the Internet 300 is a host of an Internet chat service 320. Examples of companies offering chat services are Microsoft Network™ (MSN), America On-Line™ (AOL) and Yahoo™.

Referring now to FIG. 2, this shows the functional units which are implemented by software running on microprocessor 120. There are three main units: an Internet chat application 410, electronic programme guide (EPG) store 420 and a channel selection unit 430.

The Internet chat application 410 receives user inputs from the keypad 135 and displays these on the display 130. It also comprises a block which is responsible for sending any user inputs over the Internet 300 to chat host 320 and for regularly receiving updated pages containing other users' messages. Chat messages are formatted for display by ‘display chat’ function 414.

EPG store 420 stores electronic programme guide information for a window of time, typically for the next couple of days, although it is only the immediate information which is important for this invention. Each entry in the guide generally comprises an identification of the programme (name and/or code), an identification of the channel on which it appears and the times that it is shown. An additional entry in the guide is an identifier (ID) of the programme, such as the URL of the programme's entry in the EPG provided by the EPG host 310.

Channel Selection unit 430 includes a store of channel selection options. This is a table of possible remote control inputs (e.g. ‘Television’, ‘Radio’, ‘Jukebox’, ‘channel preset #1’, ‘channel preset #37’) and remote control codes corresponding to each possible input. The store of channel selection options also includes an identifier of the broadcast channel which relates to each channel preset number. For example, the combination of user inputs ‘Television’ and ‘preset #1’ may correspond to selecting broadcast channel ‘BBC1’ on the television receiver 150. Remote control codes are sent to infrared transmitter 140 for transmission to the required consumer media presentation device (e.g. television 150) in a manner which is well known. EPG store 420 can be arranged to send EPG information to the channel selection unit 430 for display on display 130 such that a user can view what programmes are currently being shown on a range of channels.

As explained above, a user may participate in a service in which a group of users simultaneously view (or listen to) the same programmes and discuss them. There are several ways in which the commonly viewed programme can be selected. One way is to nominate a group leader who will be responsible for making the channel selections. The responsibility for acting as group leader may be passed between members. Other participants in the group, who will be called ‘followers’, allow their television or other home media presentation device to be switched between channels in response to selections made by the group leader.

In order to implement this service, chat application 410 interfaces with the channel selection unit 430 and electronic programme guide 420. When the user at the premises 100 is acting as a group leader, chat application 410 is arranged to receive a notification each time a user makes a new channel selection on their keypad 130. Upon receiving a user's selection of a new channel, channel selection unit 430 sends a request to the EPG store 420 for an identifier of the programme currently being broadcast on the selected channel. The channel selection unit 430 sends the channel name or number (e.g. ‘BBC1’) to the EPG store 420. EPG store 420 searches for a programme currently being broadcast on the channel passed to it by the channel selection unit 430. An identifier of the programme is forwarded to the chat application 410. The identifier can be a uniform resource locator (URL) to the entry in the electronic programme guide or any code which uniquely identifies the programme.

Identifiers of newly selected programmes are sent from the chat application 410, via the Internet connection 300, to the host of the chat service 320. All new identifiers are sent, together with new chat messages, to all other participants in the group. Conventional co-browsing software can be used to achieve this. Each identifier can be flagged by the chat application 410 at each terminal and/or the host 320 in a special manner to indicate that it represents media which is to be selected locally, or this may be readily apparent from the participants all being part of an active group which is operating in this way.

In its simplest form, this invention can work in a manner where the remote control of the group leader sends only an identifier of the television channel (e.g. ‘BBC1’) which is being viewed, without identifying the programme being shown on the channel. On most occasions this will work satisfactorily. However, due to regional variations in programming, i.e. a channel in one region of a country transmits a different programme to a corresponding channel in another region of the country, this is not always reliable and thus it is preferred to send an identifier of the programme that is currently being shown on the selected channel.

It is preferred that chat application 410 receives a universally recognisable identifier of the programme which is currently showing on the user selected channel. That is, the chat application should receive an identifier which can be sent to, and recognised by, all other participants in the group.

The terminals of each of the followers—participants who are following selections made by the group leader—work in the same manner. This will be described with reference to FIGS. 2 and 3.

When a new selection is made by the leader, chat host 320 sends an identifier of the target media (programme) to each of the ‘follower’ user premises. Remote control units 110 at each of the user premises receive an identifier of the target media at step 610 and this is passed to the chat application 410. Chat application 410 sends the identifier of the target media to the local electronic programme guide 420, at step 612, to determine which channel is currently showing the programme corresponding to the identifier. This may be the same channel that the group leader was viewing the programme on, or it may be a different channel.

At step 614 the chat application determines whether the appropriate channel (called a target channel) can be received by the media presentation devices at the terminal. If it can, then at step 616 the channel selection unit 430 sends an appropriate code to the infrared transmitter to instruct the local television receiver to select that channel. However, a situation may arise where the media (programme) selected by the group leader is not available for reception via the broadcast channels available to the user. As an example, the group leader may select a programme which is being broadcast on a satellite channel whereas the follower may only have access to terrestrial broadcast channels. In this case, the chat application proceeds to determine whether the same content is available from other sources. EPGs may supply alternative sources of the required content or the terminal may initiate a search based on the information it receives from the group leader. At step 617 the chat application searches for the target media (programme) from an on-line source. This is likely to be most successful where the programme is a radio programme as many radio stations broadcast their services in streamed form via the Internet. If, at step 618, the chat application is able to find an on-line source, this is selected at step 620 for presentation to the user. If an on-line source cannot be found, the chat application may instruct the browser to display a message that the media selected by the group leader is not available, at step 622 and end at step 624.

Referring again to steps 612 and 614, the EPG may identify several channels which are currently broadcasting the same target media. In this case, any one of the channels can be selected.

In parallel with the selection of new channels, both the group leader and followers can send and receive chat messages via their respective chat applications 410 to discuss the programmes which the group leader has selected. Membership of the group remains the same and discussion continues as the leader selects different channels. Individual members can, of course, leave the group as they wish and new members may join the group in the same manner as in known discussion groups.

Some hosts, such as Microsoft Network (MSN), America On-Line (AOL) and Yahoo provide more advanced features for co-ordination between multiple users. For example, each chat room will display a list of the current participants and will indicate the arrival of new participants. Users also have the options of: choosing to join their friends (usually known as ‘buddies’) in their current chat room; inviting users into particular chat rooms; or sending messages to individuals in different chat rooms. Such services usually have a membership directory which includes various information about users, such as their age, likes and dislikes. Users can view the membership directory to find other users with a similar profile to their own. Also, chat rooms are generally provided which cater for geographical or age-based “peers”.

For completeness, FIG. 4 shows an example scenario. A leader selects channel preset #12 on his satellite set-top box, at step 450, and types a chat message inviting views on his selection of programming, at step 456. The channel selection unit 430 transmits a command to the set-top box 154 to select channel preset #12, at step 452. The channel selection unit 430 uses it's look-up table to identify that channel preset #12 corresponds to the actual channel ‘Sky One’ and sends a query to the EPG 420 with this information, at step 453. EPG 420 looks for what programme is currently showing on the channel ‘Sky One’, at step 454, and finds that it is Episode 105 of ‘The Simpsons’. It also finds a URL corresponding to the entry in the programme guide and sends this URL as an identifier (ID) to the chat application 410. Chat application 410 sends the ID and the chat message to the chat host 320 at step 458. Chat host 320 distributes the chat message and ID to all members of the group, at step 460. Chat applications at the receiving terminals extract the message, for presentation 462 to the user, and the ID, which is sent, at step 464, to the EPG. The EPG identifies the programme from the URL it receives and searches for a channel which is currently showing that programme. EPG determines that channel ‘BBC2’ is showing the same programme and sends this information to the channel selection unit. The channel selection unit finds that this channel equates to preset #2 on the television receiver and sends an instruction 466 to order the television receiver to switch to that channel.

In the embodiment just described a web-enabled remote control unit 110 conveniently performs all of the tasks necessary to support the on-line chat application, transmission of control signals to the home media presentation devices and connection to the Internet. Other arrangements of equipment at a user's premises can also support the service and some of these will now be described with reference to FIG. 5.

On the left hand side of FIG. 5, a premises 101 is shown. Here, a set-top box (STB) 800 such as a set-top box supporting the Digital Video Broadcasting Multimedia Home Platform (DVB-MHP) lies at the heart of the system. STB 800 has a main processor 820 and memory 822 which support the electronic programme guide and chat application. STB 800 connects to the Internet 300 via a wired or wireless connection to an Internet gateway 105 as before. An external keyboard 835 plugs into the set-top box for user input. Electronic programme guide information may be derived from online sources, as previously described, or from broadcast sources. Windows displaying text of the chat application can be displayed alongside, or overlaid upon, the television programme itself on television 150. As before, when the user is a group leader, channel selections are recognised by the chat application and a code identifying the selected programme is derived from the online or broadcast EPG information. When the user is a follower, the chat application receives codes identifying programmes selected by the group leader, looks up a channel corresponding to the code, and issues appropriate control signals to the tuner 840 of the set-top box to select a new channel.

Premises 102 and 103 show two variants of apparatus which use a PC 850. Premises 102 shows a system using a PC, personal digital assistant (PDA) or similar device. The PC has its own keyboard 855 for user entries and a monitor 856 to display chat. The processor 853 of the PC supports the chat application 410 and electronic programme guide 420. The PC has an interface 852 for interfacing with external appliances, such as the television receiver. If a user is to make selections with a remote control handset 854, then interface 852 should be capable of receiving infrared signals from a remote control handset 854 and of transmitting remote control signals to a television or other home media presentation device. In the same way as for the remote control embodiment, the chat application determines a code, using the electronic programme guide, to represent the programme currently being viewed. The PC can also select a channel on the television by causing the interface to emit appropriate infrared signals. If a user makes channel selections using the PC itself, then the interface 852 need only be capable of transmitting control signals to external appliances.

In the variation shown at premises 103, there is no external television receiver 150. Instead, a television card 860, such as a card which plugs into a Peripheral Component Interconnect (PCI) bus of the PC, performs the function of the circuitry normally found within the receiver of a television set 150. The television card 860 has software which runs on the processor 853 of the PC and displays a graphical interface via which the user can select a broadcast channel using the keyboard 855 or mouse of the PC. The chat application running on the PC interfaces with the TV card to determine when a new channel is selected by a user and derives a code for the programme currently being shown on that channel. In this embodiment, the monitor 856 of the PC is likely to display both the window of the chat application and the video of the received broadcast channel.

It will be apparent that terminal apparatus at premises 100, 200, 250 (FIG. 1) need not be of the same type. Thus, a remote control-based apparatus at premises 100 can interact with a PC-based apparatus at premises 200 and a set-top box based apparatus at premises 250.

In the embodiment described above the remote control unit 110, or equivalent unit, includes a store of electronic programme guide (EPG) information. It is not essential to the invention to store this information at the terminal. Instead, an online or broadcast source of EPG information can be consulted on each occasion that EPG information is required. However, storing a window of EPG information at the terminal has an advantage of reducing the time between receiving a user's channel selection and providing the chat application with an identifier of the programme on that channel.

The embodiments described above have used broadcast channels as the example of media content which can be shared as a group. It is also possible to enjoy collections of stored content, such as music, audio/video clips or previously recorded broadcasts which are stored locally to each user, in a similar manner. Referring again to FIG. 1, one of the media presentation devices is a media jukebox 170. A user can select an audio or video track on the jukebox 170 in the same manner as one of the broadcast channels. There is no need to refer to the EPG store 420. Instead, an identifier of the selected media can be sent to the chat application and on to the other users. A commonly agreed way of identifying the selected media content can be used. Such schemes (e.g. metadata) are known in the art and do not need to be described further. The media jukebox 170 can be arranged to forward information about selected media content directly to the chat application whenever a new item of media content is selected. As before, in the event that a ‘follower’ terminal is unable to find an item matching the identifier from a source local to the terminal, it can attempt to find the item from an online source.

It will be appreciated that the system described above can operate without any form of return channel between the media presentation device and the terminal 110. Since the remote control 110 knows, in advance, what preset numbers on the control relate to what channels on the television and radio, it does not require any further information from those media presentation devices. However, this does not preclude the provision of a return channel. Where media presentation devices form part of a home network, a return channel may already exist between the remote control 110 and device. As an example, media jukebox 170 includes a wireless LAN transmitter/receiver unit 173 for communicating with the remote control 110. This channel can be used to provide the remote control with contents listing information and feedback on control operations.

The invention is not limited to the embodiments described herein, which may be modified or varied without departing from the scope of the invention.

In the description above, and with reference to FIG. 1, there are described terminals 110 at premises 100, 200, 250 of a group of users which allow the group to collectively experience and discuss media content selected by a member of the group. Terminals 110 are interconnected via a network (internet 300). Terminal 110 receives a first user's selection of media content, such as a television channel, for presentation by a media presentation device (e.g. television receiver 150) local to the terminal 110. Terminal 110 forwards an identifier of the selected media content to other terminals at premises 200, 250 over the network 300. Other terminals receive, via network 300, the identifiers of media content selected by the first user and instruct a media presentation device local to them to present the same media content. In the event that a terminal cannot access the selected content using one of it's local media presentation devices, it may seek an alternative source, such as an online source on the network 300.

1. A terminal (110) for allowing a first user to have a shared experience of media content with a group of other users who are interconnected with the first user via a network (300), the terminal comprising:
an input for receiving the first user's selection of media content for presentation, substantially in real-time, by a media presentation device (150, 160, 170) local to the terminal (110), the media presentation device using a delivery mechanism which is independent of the network (300);
means for determining an identifier corresponding to the selected media content;
means for sending the identifier to terminals (200, 250) of the other users in the group over the network (300); and,
means (410) for allowing the first user to discuss the media content with the other users in the group.

2. A terminal according to claim 1 further comprising:
means for receiving (112, 410), via the network (300), an identifier of media content selected by another user of the group;
means for determining a source of media content corresponding to the received identifier; and,
means for selecting the determined source on a media presentation device (150, 160, 170) local to the terminal (110).

3. A terminal according to claim 1 wherein the means for allowing the user to discuss the media content is an internet chat application (410) which communicates with an external host (320).

4. A terminal according to claim 3 wherein the identifiers of media content are sent to, or received from, the external host (320).

5. A terminal according to claim 1 wherein the identifier is a unique identifier of the media content.

6. A terminal according to claim 1 wherein the selected media content is a broadcast channel for reception on a broadcast receiver (150, 160) local to the terminal (110).

7. A terminal according to claim 6 wherein the means for determining an identifier is arranged to determine an identifier corresponding to a programme currently being broadcast on the selected channel.

8. A terminal according to claim 7 wherein the means for determining an identifier is arranged to access a source of programme information (420) to determine which programme is being broadcast on the selected broadcast channel.

9. A terminal according to claim 8 wherein the source of programme information is a source of programme information on the network (300).

10. A terminal according to claim 9 wherein the identifier is a uniform resource locator (URL) of an entry in the online source of programme information.

11. A terminal according to claim 8 wherein the source of programme information is a broadcast source of programme information.

12. A terminal according to claim 8 wherein the source of programme information is an electronic programme guide (EPG).

13. A terminal according to claims 7 wherein the broadcast receiver is a television receiver (150) or a radio receiver (160).

14. A terminal according to claim 2 wherein, when the selected media content is a broadcast channel, the means for determining a source is arranged to find a corresponding channel, or a channel broadcasting corresponding content, on a broadcast receiver (150, 160) local to the terminal (110).

15. A terminal according to claim 2 wherein, in the event that the means for determining a source is unable to locate a source which can be presented by a media presentation device (150, 160, 170) local to the terminal, the terminal (110) is arranged to find an alternative source having the same content.

16. A terminal according to claim 15 wherein the terminal is arranged to find a source on the network (300) having the same content.

17. A terminal according to claim 1 in the form of a remote control (110) for operating the media presentation device.

18. A terminal according to claim 1 in the form of a set-top box (800).

19. A terminal according to claim 1 in the form of a PC (850).

20. A terminal according to claim 19 wherein the media presentation device is a broadcast receiver (860) housed within the PC (850).

21. A terminal (110) for allowing a user to have a shared experience of media content with a group of other users who are interconnected via a network (300) comprising:
means for receiving an identifier of media content selected by another user of the group;
means for determining a source of media content corresponding to the received identifier; and,
means for selecting the determined source on a media presentation device (150, 160, 170) local to the receiver which uses a delivery mechanism which is independent of the network (300).

22. A method of operating a terminal (110) to allow a first user to have a shared experience of media content with a group of other users who are interconnected with the first user via a network (300), comprising:
receiving the first user's selection of media content for presentation, substantially in real-time, by a media presentation device (150, 160, 170) local to the terminal (110), the media presentation device (150, 160, 170) using a delivery mechanism which is independent of the network (300);
determining an identifier corresponding to the selected media content;
sending the identifier to terminals of the other users in the group over the network (300); and,
allowing the first user to discuss the media content with the other users in the group.

23. A method of operating a terminal (110) to allow a user to have a shared experience of media content with a group of other users who are interconnected with the first user via a network (300) comprising:
receiving an identifier of media content selected by another user of the group;
determining a source of media content corresponding to the received identifier; and,
selecting the determined source on a media presentation device (150, 160, 170) local to the terminal which uses a delivery mechanism which is independent of the network (300).

24. A control apparatus for a terminal (110) for allowing a first user to have a shared experience of media content with a group of other users who are interconnected via a network (300) comprising:
means for receiving the first user's selection of media content for presentation, substantially in real-time, by a media presentation device (150, 160, 170) local to the terminal (110), the media presentation device (150, 160, 170) using a delivery mechanism which is independent of the network (300);
means (420) for determining an identifier corresponding to the selected media content;
means for sending the identifier to terminals of the other users in the group over the network; and,
means (410) for allowing the first user to discuss the media content with the other users in the group.

25. A control apparatus for a terminal (110) for allowing a user to have a shared experience of media content with a group of other users who are interconnected via a network (300) comprising:
means for receiving an identifier of media content selected by another user of the group;
means for determining a source of media content corresponding to the received identifier; and,
means for selecting the determined source on a media presentation device (150, 160, 170) local to the receiver which uses a delivery mechanism which is independent of the network (300).

26. Software for causing a control apparatus of a terminal (110) for allowing a first user to have a shared experience of media content with a group of other users to perform the steps of:
receiving the first user's selection of media content for presentation, substantially in real-time, by a media presentation device (150, 160, 170) local to the terminal (110), the media presentation device (150, 160, 170) using a delivery mechanism which is independent of the network (300);
determining an identifier corresponding to the selected media content;
sending the identifier to terminals of the other users in the group over the network; and,
allowing the first user to discuss the media content with the other users in the group.

27. Software for causing a control apparatus of a terminal (110) for allowing a user to have a shared experience of media content with a group of other users who are interconnected via a network (300) to perform the steps of:
receiving an identifier of media content selected by another user of the group;
determining a source of media content corresponding to the received identifier; and,
selecting the determined source on a media presentation device (150, 160, 170) local to the terminal which uses a delivery mechanism which is independent of the network (300).

28. A method of providing a service to a group of users who are interconnected via a network (300), comprising the steps of:
receiving an identifier of a first user's selection of media content which is to be viewed by the group, the identifier representing the first user's selection of media content which is to be presented in real-time by a media presentation device (150, 160, 170) local to the first user which uses a delivery mechanism which is independent of the network (300);
sending the identifier to terminals of the other users in the group over the network (300) so as to allow terminals at those users to select the same media content on a media presentation device local to them; and,
supporting a discussion group to allow the group to discuss the selected media content.
